(19) United States
(12) Patent Application Publication
(10) Pub. No.: US 2013/0134284 A1
(43) Pub. Date: May 30, 2013

(54) GRASPING ASSEMBLY AND SUPPORT DEVICE USING THE SAME

(71) Applicants: WU-ZHU HU, Shenzhen City (CN); WU-QI LI, Shenzhen City (CN); JIN-XIN WANG, Shenzhen City (CN); TANG LI, Shenzhen City (CN)

(72) Inventors: WU-ZHU HU, Shenzhen City (CN); WU-QI LI, Shenzhen City (CN); JIN-XIN WANG, Shenzhen City (CN); TANG LI, Shenzhen City (CN)

(21) Appl. No.: 13/664,702

(22) Filed: Oct. 31, 2012

(30) Foreign Application Priority Data
Nov. 25, 2011 (CN) 201110380337.6

(51) Int. Cl. F16M 13/02; F16M 11/04

(52) U.S. Cl. 248/451; 248/206.2

(57) ABSTRACT

A grasping assembly, for grasping an electronic device, includes a fixing seat, a first grasping member securely mounted on the fixing seat, a second grasping member, and at least one elastic member mounted on the second grasping member. A resisting portion is formed on the fixing seat toward the first grasping member. The second grasping member is slidably mounted between the fixing seat and the first grasping member. A grasping portion is formed on a free end of the second grasping member away from the fixing seat. When the second grasping member slides along the fixing seat away from the first grasping member, the at least one elastic member is resisted by the resisting portion and is deformed to generate an elastic force for moving the grasping portion toward the first grasping member for grasping the electronic device.

BACKGROUND

1. Technical Field

The present disclosure relates to grasping assemblies, and particularly to a grasping assembly used in a support device for supporting an electronic device including a display screen.

2. Description of Related Art

Electronic devices with display screens, such as tablet computers and portable navigation devices, are more and more popular because of their portability factors and entertainment functions. Consumers can enjoy watching various multimedia programs when traveling in buses or on a plane. However, most grasping assemblies of the support devices can just grasp one type of electronic devices matched with the grasping assemblies, so that the support devices are limited to become unsuitable to use for other electronic devices.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an assembled, isometric view of a support device according to an embodiment of the present disclosure, which includes a grasping assembly including a supporting member and grasping an electronic device.

FIG. 2 is an exploded, isometric view of the support device of FIG. 1.

FIG. 3 is similar to FIG. 2, but viewed from another aspect.

FIG. 4 is similar to FIG. 1, but viewed from another aspect.

FIG. 5 is a cross-sectional view of the support device of FIG. 4, taken along line v-v.

FIG. 6 is an enlarged, assembled, isometric view of the grasping assembly of FIG. 1 with the supporting member being rotated and extending out.

FIG. 7 is an exploded, isometric view of the grasping assembly of FIG. 6.

### DETAILED DESCRIPTION

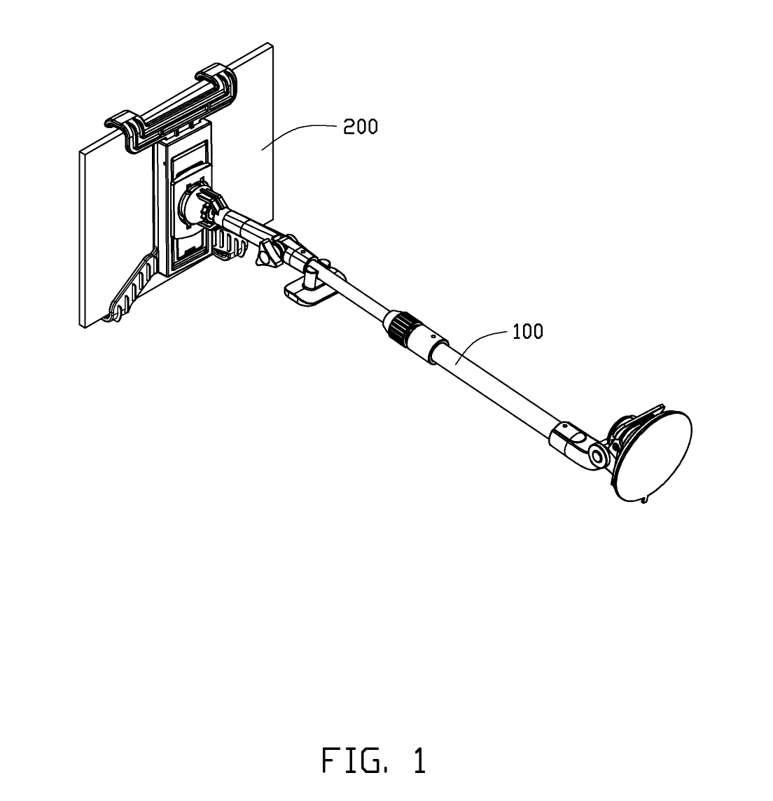

FIG. 1 shows one embodiment of a support device 100 used for fixing and supporting an electronic device 200 with a display function, such as a tablet computer or a portable navigation device, for example. The support device 100 includes a mounting member 10, a telescoping mechanism 30, a hinge mechanism 50, a grasping assembly 70, and a supporting base 90. The mounting member 10 is connected with the telescoping mechanism 30. The telescoping mechanism 30 is connected with the grasping assembly 70 via the hinge mechanism 50. The grasping assembly 70 is used for grasping the electronic device 200. The support base 90 is used for supporting the telescoping mechanism 30.

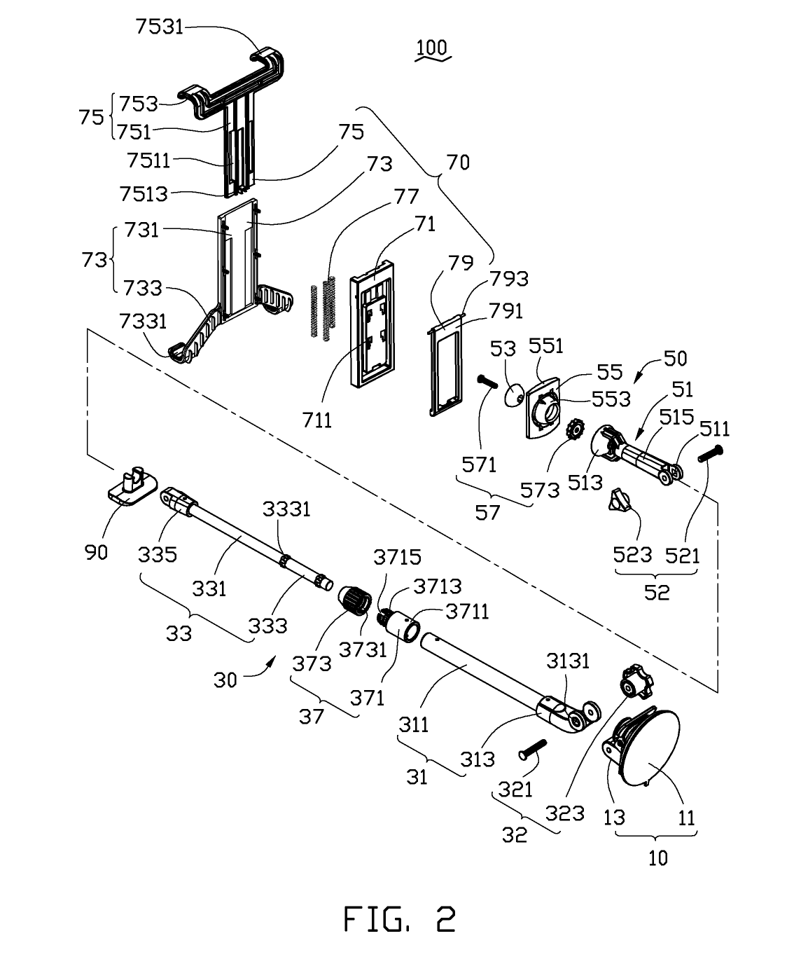

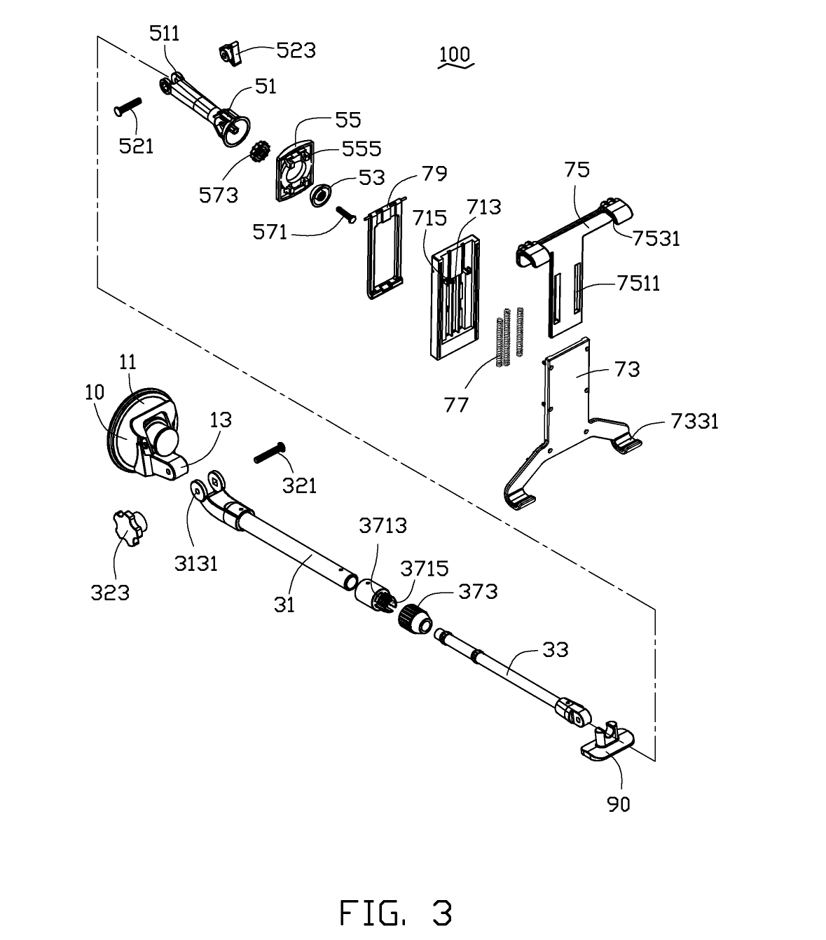

Referring also to FIGS. 2 and 3, the mounting member 10 includes a suction portion 11 and a connection portion 13 interconnecting the suction portion 11 to the telescoping mechanism 30. In the illustrated embodiment, the suction portion 11 is a rubber suction cup.

The telescoping mechanism 30 includes a first connection shaft 31, a first adjustment assembly 32, a second connection shaft 33, and a second adjustment assembly 37. The first connection shaft 31 is connected with the mounting member 10 via the first adjustment assembly 32. The second connection shaft 33 is slidably sleeved in the first connection shaft 31. A length of the telescoping mechanism 30 can be adjusted via the second adjustment assembly 37.

The first connection shaft 31 includes a body 311 and a hinge portion 313 connected with one end of the body 311. The body 311 is a hollow cylinder. The hinge portion 313 includes a hinge end 3131, away from the body 311 and pivotably connected with the mounting member 10.

The first adjustment assembly 32 includes an adjustment member 321 and an adjustment cap 323. The adjustment member 321 passes through the connection portion 13 of the mounting member 10 and the hinge end 3131 of the first connection shaft 31. The adjustment cap 323 is threadedly connected with the adjustment member 321, such that an angle formed between the mounting member 10 and the first connection shaft 31 can be adjusted.

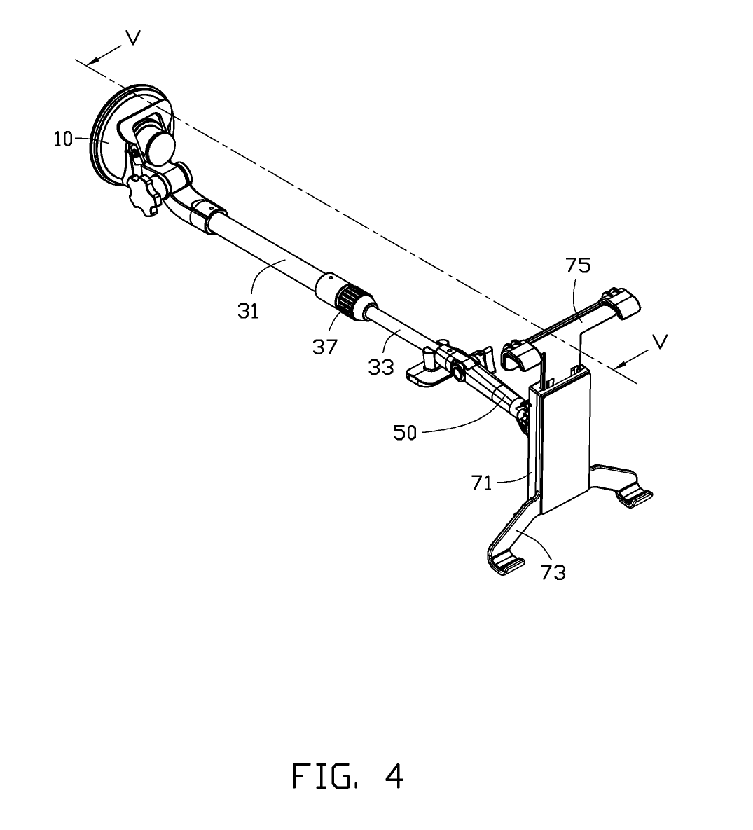

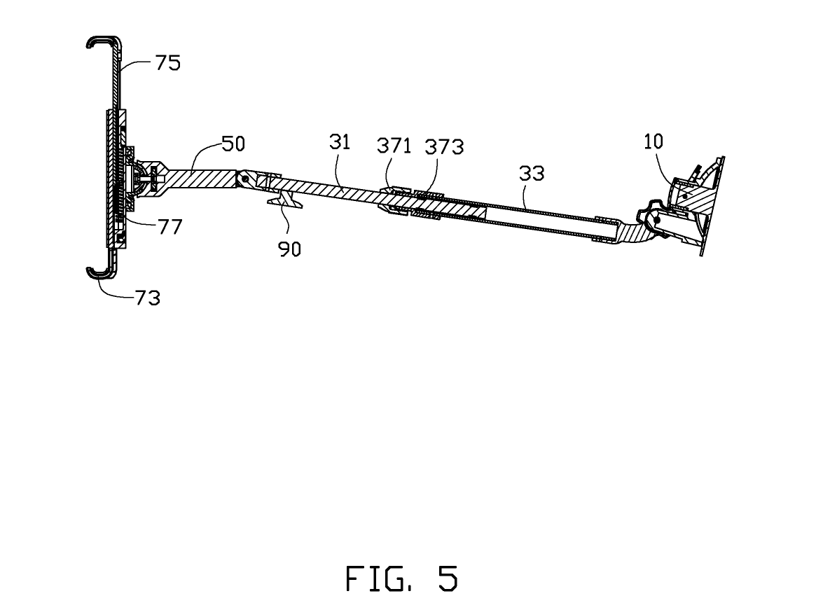

Referring also to FIGS. 4, and 5, a second connection shaft 33 includes a body 331, an extension portion 333, two friction members 3331, and a hinge portion 335. The body 331 is cylinder-like. An outer diameter of the body 331 is smaller than an inner diameter of the body 311 of the first connection shaft 31. The extension portion 333 extends from one end of the body 331 toward the first connection shaft 31. The body 331 and the extension portion 333 are slidably sleeved in the body 311 of the first connection shaft 31. The friction washers 3331 are sleeved on the body 331, and spaced from each other, to prevent the second connection shaft 33 from shaking. In the illustrated embodiment, the friction washers 3331 are made of soft materials. The hinge portion 335 is formed on the other end of the body 331 away from the extension portion 333, and is pivotably connected with the hinge mechanism 50.

The second adjustment assembly 37 includes a locking member 371 and an engaging member 373. The locking member 371 includes a body 3711 and a threaded portion 3713 extending from the body 3711. The body 3711 is hollow cylinder. An inner diameter of the body 3711 is greater than an outer diameter of the body 311 of the first connection shaft 31. The body 3711 is securely sleeved on one end of the body 311 away from the mounting member 10. Three latching notches 3715 are defined in the threaded portion 3713, and are evenly spaced from each other. The engaging member 373 is slidably sleeved on the body 331, and includes an engaging portion 3731 formed on an inner surface thereof. The engaging portion 3731 is threadedly engaged with the threaded portion 3713. The extension portion 333 of the second connection shaft 33 passes through the threaded portion 3713. Because of the latching notches 3715, the extension portion 333 can be locked or released by the engaging member 373.

The hinge mechanism 50 is pivotably connected with the second connection shaft 33, and includes a rotation shaft 51, a first connection assembly 52, a rotation member 53, an engaging seat 55, and a second connection assembly 57. The rotation shaft 51 is connected with the second connection shaft 33 via the first connection assembly 52. The engaging seat 55 is placed between the rotation shaft 51 and the rotation member 53 via the second connection assembly 57.

The rotation shaft 51 includes a connection end 511 connected with the second connection shaft 33, a pivot end 513 opposite to the connection end 511, and a shaft portion 515 between the connection end 511 and the pivot end 513. The pivot end 513 is a hollow hemisphere, such that the engaging seat 55 is rotatably mounted in the pivot end 513. The first connection assembly 52 includes a connection member 521 and a connection cap 523. The connection member 521 passes through the connection end 511 and the hinge portion 335, and the connection cap 523 is engaged with a free end of the connection member 521, such that an angle formed between the rotation shaft 51 and the second connection shaft 33 can be adjusted.

The rotation member 53 is substantially a hemisphere. The engaging seat 55 includes a base 551, a receiving portion 553, and a plurality of latching portions 555. The base 551 is substantially a rectangular plate defining a through hole in a center thereof. The receiving portion 553 is substantially a hollow hemisphere, and is protruded from a periphery of the through hole of the base 551 toward the rotation shaft 51. The latching portions 555 are extended from one side of the base 551 away from the rotation shaft 51, and are symmetrically spaced from each other. In the illustrated embodiment, a number of the latching portions 555 is four. In other embodiments, the number of the latching portions 555 can be changed. The second connection assembly 57 is similar to the first connection assembly 52, and includes a connection member 571 and a connection cap 573 received in the pivot end 513. The connection member 571 passes through the rotation member 53, the receiving portion 553, and the pivot end 513 in that order, and then is threadedly engaged with the connection cap 573.

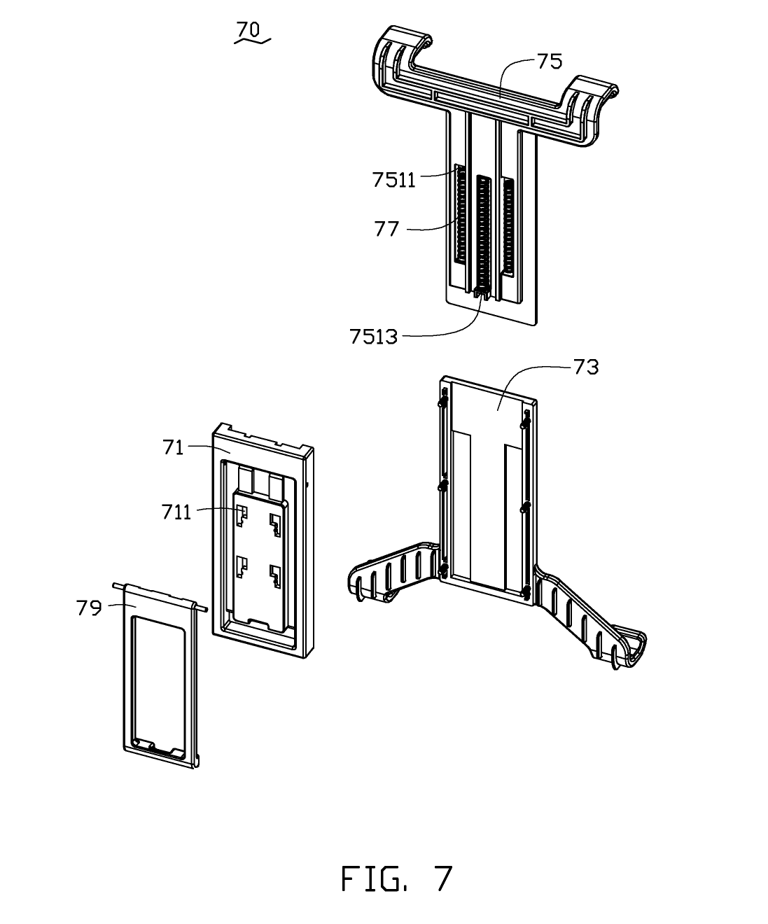

Referring also to FIG. 7, the grasping assembly 70 includes a fixing seat 71, a first grasping member 73, a second grasping member 75, three elastic members 77, and a supporting member 79. The fixing seat 71 is substantially a rectangular plate. A plurality of latching holes 711 is defined in the fixing seat 71, and engaged with the corresponding latching portions 555. A receiving groove 713 is defined in the fixing seat 71 adjacent to the latching holes 711, for receiving one of the elastic members 77. Two resisting portions 715 are formed on the fixing seat 71 adjacent to the receiving groove 713, for resisting the other elastic members 77. The first grasping member 73 includes a body portion 731 and a plurality of first grasping portions 733. The body portion 731 is substantially a rectangular plate securely mounted on the fixing seat 71. The body portion 731 and the fixing seat 71 cooperatively form a receiving space (not shown). The first grasping portions 733 are extending from a sidewall of the body portion 731 adjacent to an end of the body portion 731, and are symmetrical with each other. In the illustrated embodiment, a number of the first grasping portions 733 is two. A positioning groove 7331 is defined in a free end of each first grasping portion 733, for latching the electronic device 200.

The second grasping member 75 has a similar structure to the first grasping member 73. The second grasping member 75 includes a body portion 751 and a plurality of second grasping portions 753. The body portion 751 is substantially a rectangular plate. The body portion 751 is mounted in the receiving space, and slidable relative to the first grasping member 73. Two mounting holes 7511 are defined in the body portion 751, for receiving another two of the elastic members 77. The resisting portions 715 pass through the ends of the corresponding mounting holes 7511, and resist the ends of the corresponding elastic members 77 received in the mounting holes 7511. A resisting portion 7513 is formed between the mounting holes 7511 toward the fixing seat 71. The resisting portion 7513 pass through one end of the receiving groove 713 to resist the elastic member 77 received in the receiving groove 713. The second grasping portions 753 are extending from a sidewall of the body portion 751 adjacent to an end of the body portion 751, and are symmetrical with each other. In the illustrated embodiment, the number of the second grasping portions 753 is two. A positioning groove 7531 is defined in a free end of each second grasping portion 753, for latching the electronic device 200.

As described as above, two of the three elastic members 77 are received in the mounting holes 7511 defined in the second grasping member 75, and each end of the two elastic members 77 is elastically resisted by the corresponding resisting portion 715 of the fixing seat 71. The other one elastic member 77 is received in the receiving groove 713 defined in the fixing seat 71, and one end of the other one elastic member 77 is elastically resisted by the resisting portion 7513 of the second grasping member 75. In the illustrated embodiment, the elastic member 77 is a spring. In other embodiments, the other one elastic member 77 and the resisting portion 7513 can be omitted.

The supporting member 79 is mounted on the fixing seat 71, and is a substantially rectangular plate defining an opening. A pivot portion 791 is formed on one end of the supporting member 79. The pivot portion 791 is pivotably connected with the fixing seat 71 via a shaft 793.

The supporting base 90 is mounted below the second connection shaft 33 of the telescoping mechanism 30, for supporting the second connection shaft 33.

In assembly, the connection portion 13 of the mounting member 10 is first pivotably connected with the hinge portion 313 of the first connection shaft 31 via the first adjustment assembly 32; second, the locking member 371 of the second adjustment assembly 37 is securely sleeved on one end of the body 311 of the first connection shaft 31, the engaging member 373 is slidably sleeved on the body 331, the second connection shaft 33 is slidably sleeved in the first connection shaft 31, and then the locking member 371 is engaged with the engaging member 373, thereby the first connection shaft 31 is slidably sleeved on the second connection shaft 33; third, the rotation shaft 51 of the hinge mechanism 50 is pivotably connected with the hinge portion 335 of the second connection shaft 33 via the first connection assembly 52, the engaging seat 55 is placed between the rotation shaft 51 and the rotation member 53, and is latched with the fixing seat 71 of the grasping assembly 70, thereby connecting the hinge mechanism 50 with the second connection shaft 33 and the grasping assembly 70; fourth, the resisting portions 715 pass through the corresponding mounting holes 7511, the resisting portion 7513 is received in the receiving groove 713, two elastic members 77 are received in the mounting holes 7511 and resisted by the corresponding resisting portions 715, and the other one elastic member 77 is received in the receiving groove 713 and resisted by the resisting portion 7513, thereby the elastic members 77 are appropriately placed in their respective locations; at last, the supporting base 90 is mounted below the second connection shaft 33 of the telescoping mechanism 30.

In use, the mounting member 10 is first mounted on a predetermined position, and a relative angle formed between the first connection shaft 31 and the mounting member 10 is adjusted by the first adjustment assembly 32; second, the locking member 371 and the engaging member 373 are unlocked so that the second connection shaft 33 slides out from the first connection shaft 31; and when the second connection shaft 33 slides to a predetermined position, the second adjustment assembly 37 is locked to fix the second connection shaft 33 relative to the first connection shaft 31; at last, an angle formed between the hinge mechanism 50 and the second connection shaft 33 is adjusted by the rotation shaft 51. When a sight or viewing angle is needed to be adjusted, the connection cap 573 is unlocked to release the engaging seat 55, the rotation shaft 51, and the rotation member 53, and an angle formed between the engaging seat 55, the rotation member 53, and the rotation shaft 51 is adjusted, and then the connection cap 573 is locked, thereby fixing the rotation member 53 and the rotation shaft 51 at a predetermined angle. When the second grasping member 75 slides out from the first grasping member 73, the elastic members 77 are deformed to generate an elastic force; then, the electronic device 200 is placed in the first grasping portions 733; at last, the second grasping member 75 is released, and the electronic device 200 is thereby securely grasped by the first grasping portions 733 and the second grasping portions 753.

Because the second grasping member 75 is slidable relative to the first grasping member 73 via the elastic members 77, the supporting device 100 is adjustable to accommodate for various electronic devices 200 having different sizes. In addition, a pitch or viewing angle of the electronic device 200 can be adjusted by the first adjustment assembly 32 or the first connection assembly 52, such that a user can achieve a better viewing performance

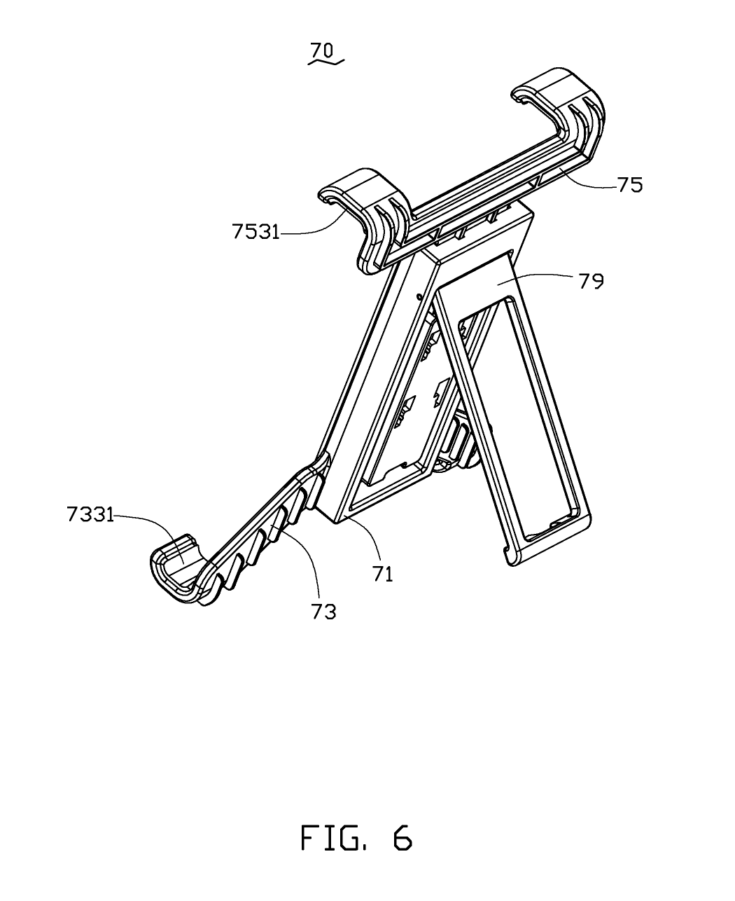

In other embodiments, when the grasping assembly 70 is used separately, the supporting member 79 is rotated out from the fixing seat 71 to support the fixing seat 71, as shown in FIG. 6. The hinge mechanism 50 can be omitted, and the grasping assembly 70 is directly connected with the second connection shaft 33.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A support device, for supporting an electronic device, comprising:
a telescoping mechanism; and
a grasping assembly connected with the telescoping mechanism for grasping the electronic device, the grasping assembly comprising:
a fixing seat;
a first grasping member securely mounted on the fixing seat;
a second grasping member; and
at least one elastic member mounted on the second grasping member, wherein a resisting portion is formed on the fixing seat toward the first grasping member, the second grasping member is slidably mounted between the fixing seat and the first grasping member, a grasping portion is formed on a free end of the second grasping member away from the fixing seat, and when the second grasping member slides along the fixing seat away from the first grasping member, the at least one elastic member is resisted by the resisting portion and is deformed to generate an elastic force for moving the grasping portion toward the first grasping member for grasping the electronic device.

2. The support device of claim 1, wherein at least one mounting hole is defined in the second grasping member, and the at least one elastic member is received in the at least one mounting hole and one end of the elastic member resists the resisting portion.

3. The support device of claim 1, wherein the telescoping mechanism comprises a first connection shaft, a second connection shaft, and an adjustment assembly, the second connection shaft is slidably sleeved in the first connection shaft, and the second connection shaft is locked or released by the adjustment assembly, such that a length of the telescoping mechanism is adjustable.

4. The support device of claim 3, wherein the adjustment assembly comprises a locking member and an engaging member threadedly engaged with the locking member, the locking member is securely sleeved on one end of the first connection shaft, and the engaging member is slidably sleeved on the second connection shaft.

5. The support device of claim 4, wherein the locking member comprises a threaded portion, the engaging member comprises an engaging portion, and the engaging portion is threadedly engaged with the threaded portion.

6. The support device of claim 5, wherein the support device further comprises a hinge mechanism, the hinge mechanism interconnects the telescoping mechanism to the grasping assembly, the hinge mechanism comprises a rotation shaft, a rotation member, an engaging seat, and at least one connection assembly, the engaging seat is connected with the fixing seat, the telescoping mechanism is connected with the rotation shaft, the at least one connection assembly comprises a connection member and a connection cap, and the connection member passes through the rotation member, the engaging seat, and the rotation shaft in that order, and then is threadedly engaged with the connection cap, such that the engaging seat is locked or released by the connection assembly, and an angle formed between the engaging seat and the telescoping mechanism is adjustable.

7. The support device of claim 3, wherein the support device further comprises a mounting member, the mounting member comprises a connection portion, the telescoping mechanism further comprises another adjustment assembly, the first connection shaft is pivotedly connected with the connection portion of the mounting member via the another adjustment assembly.

8. A support device, for supporting an electronic device, comprising:
a telescoping mechanism comprising a first connection shaft, a second connection shaft slidably sleeved in the first connection shaft, and an adjustment assembly, wherein the second connection shaft is locked or released by the adjustment assembly; and
a grasping assembly connected with the second connection shaft of the telescoping mechanism for grasping the electronic device, the grasping assembly comprising:
a fixing seat;
a first grasping member securely mounted on the fixing seat;
a second grasping member defining at least one mounting hole; and
at least one elastic member received in the at least one mounting hole, wherein a resisting portion is formed on the fixing seat toward the first grasping member, the second grasping member is slidably mounted between the fixing seat and the first grasping member, a grasping portion is formed on a free end of the second grasping member away from the fixing seat, and when the second grasping member slides along the fixing seat away from the first grasping member, the at least one elastic member is resisted by the resisting portion and is deformed to generate an elastic force for moving the grasping portion toward the first grasping member for grasping the electronic device.

9. The support device of claim 8, wherein the adjustment assembly comprises a locking member and an engaging member threadedly engaged with the locking member, the locking member is securely sleeved on one end of the first connection shaft, and the engaging member is slidably sleeved on the second connection shaft.

10. The support device of claim 9, wherein the locking member comprises a threaded portion, the engaging member comprises an engaging portion, and the engaging portion is threadedly engaged with the threaded portion.

11. The support device of claim 10, wherein the support device further comprises a hinge mechanism, the hinge mechanism interconnects the telescoping mechanism to the grasping assembly, the hinge mechanism comprises a rotation shaft, a rotation member, an engaging seat, and a connection assembly, the engaging seat is connected with the fixing seat, the second connection shaft of the telescoping mechanism is connected with the rotation shaft, the connection assembly comprises a connection member and a connection cap, and the connection member passes through the rotation member, the engaging seat, and the rotation shaft in that order, and then is threadedly engaged with the connection cap, such that the engaging seat is locked or released by the connection assembly, and an angle formed between the engaging seat and the telescoping mechanism is adjustable.

12. The support device of claim 8, wherein the support device further comprises a mounting member, the mounting member comprises a connection portion, the telescoping mechanism further comprises another adjustment assembly, the first connection shaft is pivotably connected with the connection portion of the mounting member via the another adjustment assembly.

13. A grasping assembly, for grasping an electronic device, comprising:
a fixing seat;
a first grasping member securely mounted on the fixing seat;
a second grasping member; and
at least one elastic member received in the second grasping member, wherein a resisting portion is formed on the fixing seat toward the first grasping member, the second grasping member is slidably mounted between the fixing seat and the first grasping member, a grasping portion is formed on a free end of the second grasping member away from the fixing seat, and when the second grasping member slides along the fixing seat away from the first grasping member, the at least one elastic member is resisted by the resisting portion and is deformed to generate an elastic force for moving the grasping portion toward the first grasping member for grasping the electronic device.

14. The support device of claim 13, wherein at least one mounting hole is defined in the second grasping member, the at least one elastic member is received in the at least one mounting hole and one end of the at least one elastic member resists the resisting portion.

15. The grasping assembly of claim 13, wherein the grasping assembly further comprises a supporting member pivotably connected with the fixing seat, for supporting the fixing seat.
